(19) United States
(12) Patent Application Publication
(10) Pub. No.: US 2006/0011222 A1
(43) Pub. Date: Jan. 19, 2006

(54) Apparatus for treating substrates

(75) Inventor: Young-sik Lee, Chungcheongnam-do (KR)

Correspondence Address: David W. Heid;MacPHERSON KWOK CHEN & HEID LLP, Suite 226, 1762 Technology Drive, San Jose, CA, 95110, US

(73) Assignee: Samsung Electronics Co., Ltd.

(21) Appl. No.: 11/171,571

(22) Filed: Jun. 29, 2005

(30) Foreign Application Priority Data
Jul. 1, 2004 (KR) 2004-0051225
Jul. 28, 2004 (KR) 2004-0059312

(51) Int. Cl. B08B 3/00

(52) U.S. Cl. 134/61; 134/151; 134/82; 134/198

(57) ABSTRACT

An apparatus for treating substrate comprising, a moving mechanism for moving a substrate and a high pressure spray unit comprising a first high pressure spray having a first nozzle portion disposing transverse to the direction of movement of the substrate and a second high pressure spray having a second nozzle portion parallel to the first nozzle portion.

### CROSS-REFERENCE TO RELATED APPLICATIONS

This application claims the benefit of Korean Patent Application No. 2004-0059312, filed on Jul. 28, 2004, and No. 2004-0051225, filed on Jul. 1, 2004, in the Korean Intellectual Property Office, the disclosures of which are incorporated by reference herein in their entireties.

### BACKGROUND OF THE INVENTION

1. Field of the Invention

The present invention relates to an apparatus for treating a substrate, and more particularly, to an apparatus for treating a substrate by supplying a treating fluid to a substrate for washing and/or drying of the substrate.

2. Description of the Related Art

A liquid crystal display (LCD) comprises a liquid crystal panel which comprises a thin film transistor (TFT) substrate, a color filter substrate, and a liquid crystal layer sandwiched between both substrates. Since the liquid crystal panel does not emit light itself, a backlight unit may be located behind the TFT substrate to supply light to the liquid crystal panel. The transmittance of light from the backlight unit depends on the alignment of the liquid crystal layer.

In addition, the LCD may further comprise a driving circuit, a data driver and a gate driver to drive a pixel of the liquid crystal panel, wherein the data driver and the gate driver receive a driving signal from the driving circuit and then apply a driving voltage on a data line and a gate line within a display area respectively.

In making the TFT substrate and the color filter substrate, etching and developing are performed to form a pattern on the surface of the substrate. Further, washing and drying are performed before and/or after etching and developing.

In etching and developing, an etching solution and a developing solution are applied to the substrate to treat the substrate. A portion of the etching solution and the developing solution remain on the substrate after etching and developing. The remaining etching solution and developing solution are removed from the substrate through washing.

In washing, a washing fluid (for example, deionized water) is applied to the substrate. The remaining etching solution and developing solution are removed from the substrate by the washing fluid.

A portion of the washing fluid remains on the substrate after washing. The remaining washing fluid is removed through drying. In drying, an air flow is applied to the substrate. The air flow may be heated to increase the speed of drying.

However, as the size of the substrate increases, the lack of uniformity in the washing and drying steps also increases.

### SUMMARY

Accordingly, in one aspect, an apparatus for treating a substrate that treats the substrate uniformly is provided.

Additional aspects and/or advantages provided by embodiments of the present invention will be set forth in part in the description which follows and, in part, will be obvious from the description, or may be learned by practice of the present invention.

The foregoing and/or other aspects of the present invention can be achieved by providing an apparatus for treating substrate comprising: a moving mechanism for moving a substrate; a high pressure spray unit comprising a first high pressure spray having a first nozzle portion disposed transverse to the direction of the moving direction of the substrate and a second high pressure spray having a second nozzle portion parallel to the first nozzle portion.

According to another aspect of the invention, at least one of the first nozzle portion and the second nozzle portion directs fluid at an oblique angle to the surface of the substrate.

According to another aspect of the invention, a treating fluid from the first high pressure spray is applied to the substrate prior to a treating fluid from the second high pressure spray, and the treating fluid from the first high pressure spray comprises air and the treating fluid from the second high pressure spray comprises water.

According to another aspect of the invention, a treating fluid from the first high pressure spray is applied to the substrate prior to application of a treating fluid from the second high pressure spray, and the treating fluid from the first high pressure spray comprises room-temperature air and the treating fluid from the second high pressure spray comprises heated air.

According to another aspect of the invention, the apparatus further comprises a widthwise high pressure spray having a widthwise nozzle portion disposed along the direction of movement of the substrate.

The foregoing and/or other aspects of the present invention can be also achieved by providing an apparatus for treating substrates comprising: a moving mechanism for moving a substrate; and a widthwise high pressure spray having a widthwise nozzle portion disposed along the direction of movement of the substrate.

According to another aspect of the invention, the apparatus further comprises a lengthwise high pressure spray having a lengthwise nozzle portion disposed transverse to the direction of movement of the substrate.

According to another aspect of the invention, a treating fluid from the widthwise high pressure spray and the lengthwise high pressure spray comprises water.

According to another aspect of the invention, the moving mechanism supports the substrate at an inclined angle, and the widthwise high pressure spray is disposed along an elevated edge of the substrate.

The foregoing and/or other aspects of the present invention can be also achieved by providing an apparatus for treating substrates, comprising: a moving mechanism for moving a substrate in a first direction; and a washing module comprising a first high pressure spray unit. The first high pressure spray unit comprises: a first elongate spray nozzle extending across a length of the substrate transverse to the first direction, and a second elongate spray nozzle extending across a width of the substrate parallel to the first direction.

### BRIEF DESCRIPTION OF THE DRAWINGS

These and other aspects and advantages of the present invention will become apparent and more readily appreciated from the following description of the embodiments, taken in conjunction with the accompanying drawings of which:

FIG. 1 is a cross-sectional view of an apparatus for treating substrate according to a first embodiment of the present invention;

FIG. 2 is a perspective view of a washing module according to the first embodiment of the present invention;

FIG. 3 is a cross-sectional view of an apparatus for treating substrate according to a second embodiment of the present invention;

FIG. 4 is a perspective view of a washing module according to the second embodiment of the present invention;

FIG. 5 is a cross-sectional view of an apparatus for treating substrate according to a third embodiment of the present invention.

### DETAILED DESCRIPTION

Reference will now be made in detail to the embodiments of the present invention, examples of which are illustrated in the accompanying drawings, wherein like reference numerals refer to like elements throughout. The embodiments are described below in order to explain the present invention by referring to the figures.

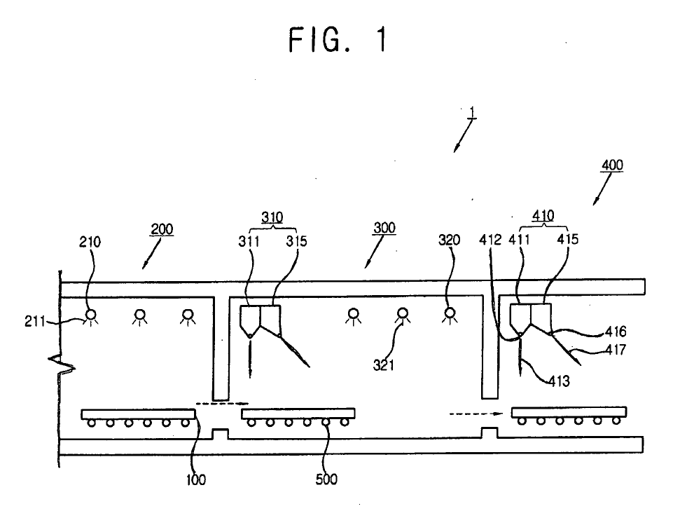

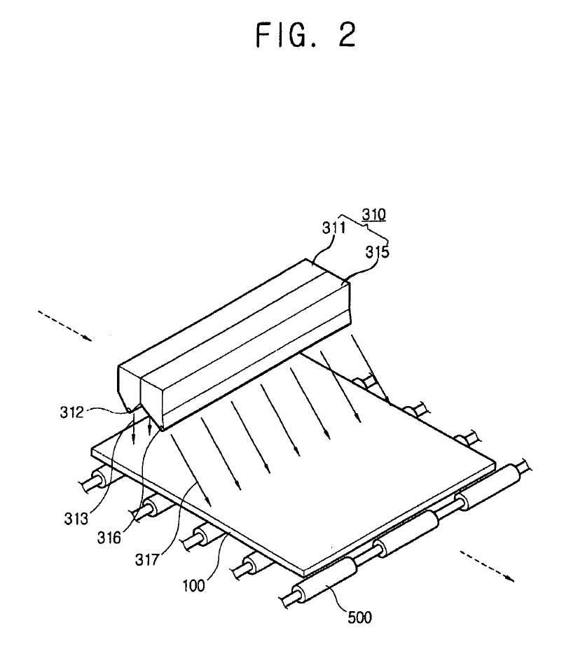

An apparatus for treating a substrate according to a first embodiment of the present invention will be described with reference to FIGS. 1 and 2.

FIG. 1 is a cross-sectional view of an apparatus 1 for treating a substrate according to the first embodiment of the present invention, and FIG. 2 is a perspective view of a washing module according to the first embodiment of the present invention.

The apparatus 1 for treating a substrate comprises an etching module 200, a washing module 300, a drying module 400, and a moving mechanism 500 for moving a substrate 100 to be treated.

In the etching module 200, a portion of the metal layer, electrode layer, or insulating layer to be etched is exposed. A photoresist layer is formed on the portions that are not to be etched.

The etching module 200 comprises a spray module 210 for applying an etching solution 211 to the substrate 100. A plurality of spray modules 210 may be provided to apply the etching solution 211 uniformly across the surface of the substrate 100.

The composition of the etching solution 211 depends on the object to be etched. The etching solution 211 may comprise phosphoric acid, nitric acid, and acetic acid for aluminum or molybdenum, which is widely used for gate wiring or data wiring. The etching solution 211 may comprise fluoric acid and nitric acid for tantalum. The etching solution 211 may comprise ammonium nitrate, cesium, and nitric acid for chrome. The etching solution 211 may comprise hydrochloric acid, nitric acid, and iron chloride for ITO (indium tin oxide), which is used for pixel electrodes.

The etching module 200 further comprises an etching solution storage tank (not shown) and an etching solution supply mechanism (not shown) to supply the etching solution 211 from the etching solution storage tank to the spray module 210.

The moving mechanism 500 is a conveyer belt type mechanism which moves the substrate 100 from the etching module 200 to the drying module 400. The substrate 100 may have a rectangular shape, and the moving mechanism 500 may move the substrate 100 such that a longer side of the substrate 100 is parallel to the direction of movement of the substrate 100. Further, the moving mechanism 500 may support the substrate 100 at an inclined angle so as to improve the ease and speed with which the etching solution 211 is removed from the upper surface of the substrate 100.

The washing module 300 comprises a high pressure spray unit 310 and a spray module 320.

The high pressure spray unit 310 comprises a first high pressure spray 311 having a first nozzle portion 312 extending laterally across the substrate 100 in a direction substantially perpendicular to the direction of travel of the substrate 100. The high pressure spray unit 310 also comprises a second high pressure spray 315 having a second nozzle portion 316, which extends laterally across the substrate 100 in a direction substantially parallel to the first nozzle portion 312. The first high pressure spray 311 and the second high pressure spray 315 are formed as a single body. A treating fluid from the first high pressure spray 311 comprises a gas 313, such as air, and a treating fluid from the second high pressure spray 315 comprises a washing fluid 317, such as deionized water.

The first nozzle portion 312 is configured to direct the high-pressure air 313 in a direction substantially perpendicular to the surface of the substrate 100. The second nozzle portion 316 is configured to direct the washing fluid 317 at a predetermined oblique angle to the surface of the substrate 100.

A plurality of spray modules 320 may be provided to supply a washing fluid 321 as the treating fluid to the substrate 100.

The moving mechanism 500 may support the substrate 100 at an inclined angle relative to the direction of movement of the substrate 100 while the substrate 100 is in the washing module 300, as well as in the etching module 200.

The washing module 300 further comprises a washing fluid storage tank (not shown), a washing fluid supply mechanism (not shown) to supply the washing fluid 317 and washing fluid 321 to the high pressure spray unit 310 and the spray module 320, and a compressor (not shown) to supply compressed air to the high pressure spray unit 310.

The drying module 400 comprises a high pressure spray unit 410. The high pressure spray unit 410 comprises a first high pressure spray 411 having a first nozzle portion 412 extending laterally across the substrate 100 in a direction substantially perpendicular to the direction of travel of the substrate 100. The high pressure spray unit 410 also comprises a second high pressure spray 415 having a second nozzle portion 416, which extends laterally across the substrate 100 in a direction substantially parallel to the first nozzle portion 412. The first high pressure spray 411 and the second high pressure spray 415 are formed as a single body. A treating fluid from the first high pressure spray 411 comprises room temperature air 413 and a treating fluid from the second high pressure spray 415 comprises heated air 417.

The first nozzle portion 412 is configured to supply the room temperature air 413 in a direction substantially perpendicular to the surface of the substrate 100. The second nozzle portion 416 is configured to supply the heated air 417 at a predetermined oblique angle to the surface of the substrate 100.

A method of forming gate wiring on the substrate 100 using the apparatus for treating a substrate according to the first embodiment of the present invention will be described.

A gate metal layer is deposited on an insulating substrate. A photoresist solution is coated on the gate metal layer. A photoresist layer is formed by a removing solvent in the photoresist solution using a soft-bake process. A mask is used to expose portions of the photoresist layer to light in a predetermined pattern. The photoresist layer is then developed to form a photoresist pattern on the gate metal layer. The portions of the gate metal layer not covered by the photoresist pattern are removed using the following process.

In the etching module 200, the spray module 210 applies the etching solution 211 to the surface of the substrate 100. The etching solution 211 may comprise phosphoric acid, nitric acid, and acetic acid when the gate metal layer is formed of aluminum or molybdenum. The portions of the gate metal layer gate metal layer not covered by the photoresist pattern are etched by the etching solution 211. The portions of the gate metal layer covered by the photoresist pattern remain to form the gate wiring.

Next, the moving mechanism 500 moves the substrate 100 having the etched gate metal layer to the washing module 300. The moving mechanism 500 may support the substrate 100 at an inclined angle.

Portions of the gate metal layer material separated from the substrate 100 during the etching process and portions of the etching solution 211 which remain on the substrate 100 are removed in the washing module 300. The washing fluid 317 from the second high pressure spray 315 is applied to the substrate 100 in large volumes to remove the remaining gate metal layer material and etching solution 211, before the washing fluid 321 from the spray module 320 is applied. The air 313 from the first high pressure spray 311 prevents the washing fluid 317 from flowing backward to the etching module 200, thereby helping to prevent the concentration of the etching solution 211 in the etching module 200 from changing and to prevent the etching process from becoming unstable.

In the washing module 300, the first high pressure spray 311 supplies the air 313 and the second high pressure spray 315 supplies the washing fluid 317 to the substrate 100. As the first high pressure spray 311 and the second high pressure spray 315 are formed as a single body, the interval between the supplying of the air 313 and the supplying of the washing fluid 317 is short. Accordingly, the washing of the substrate 100 is performed in a short time and in a uniform fashion, thus reducing the generation of spots on the substrate 100. Further, the high pressure spray unit 310 used to supply the air 313 and the washing fluid 317 is compact and does not consume an excessive amount of space.

The washing fluid 317 from the second high pressure spray 315 is applied to the substrate 100 at a predetermined oblique angle to the surface of the substrate 100. Accordingly, an interval is provided between areas of the substrate 100 being supplied with the washing fluid 317 and the air 313. This interval prevents the washing fluid 317 from flowing backward into the etching module 200.

The high pressure spray unit 310 removes the etching solution and the etched gate metal layer material from the substrate 100 quickly. In addition, the spray module 320 further supplies the washing fluid 321 to wash the substrate 100.

Next, the moving mechanism 500 moves the substrate 100 from the washing module 300 to the drying module 400.

In the drying module 400, the first high pressure spray 411 directs pressurized room temperature air 413 to surface of the substrate 100. Next, the second high pressure spray 415 directs pressurized heated air 417 to the surface of the substrate 100. As the first high pressure spray 411 and the second high pressure spray 415 are formed as a single body, the interval between the supplying of the room temperature air 413 and the supplying of the heated air 417 is short. Accordingly, the drying of the substrate 100 is performed in a short time and in a uniform fashion, thus reducing the generation of spots on the substrate 100. Further, the high pressure spray unit 410 used to supply the room temperature air 413 and the heated air 417 is compact and does not consume an excessive amount of space.

The high pressure spray unit 310, 410 may be modified in various ways. The high pressure spray unit 310, 410 may comprise 3 or more high pressure sprays. The high pressure spray units 310, 410 may supply washing fluid or air only.

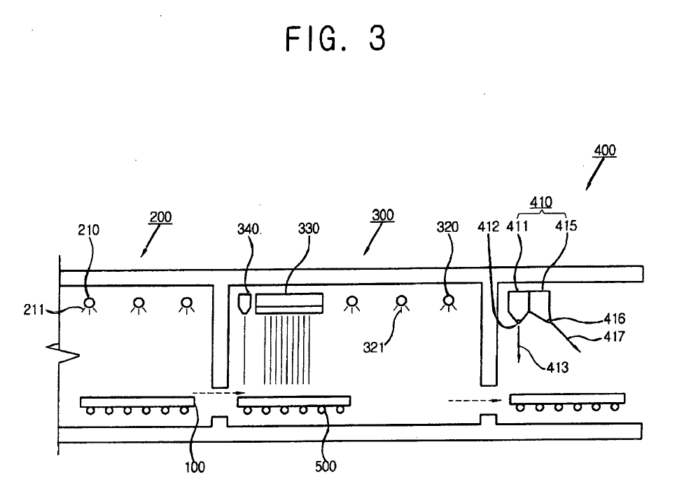

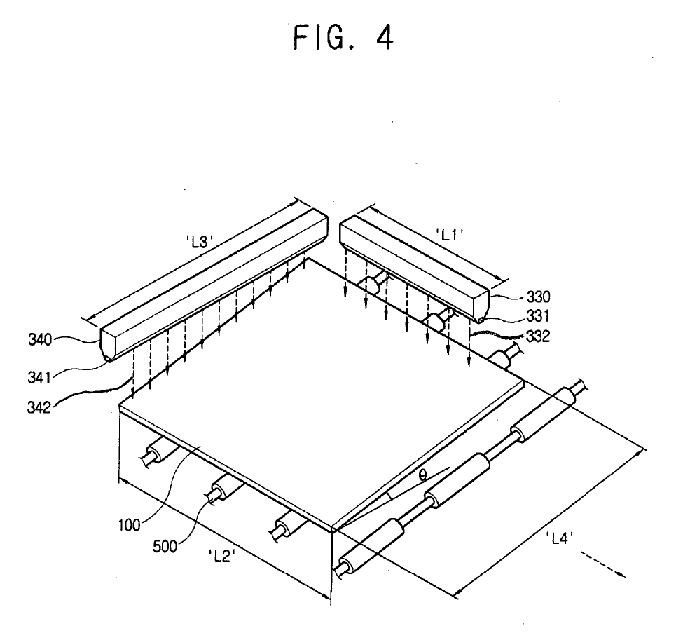

An apparatus for treating a substrate according to a second embodiment of the present invention will be described with reference to FIGS. 3 and 4.

FIG. 3 is a cross-sectional view of the apparatus for treating a substrate according to the second embodiment of the present invention, and FIG. 4 is a perspective view of a washing module according to the second embodiment of the present invention.

The washing module 300 comprises a spray module 320, a widthwise high pressure spray 330, and a lengthwise high pressure spray 340. The widthwise high pressure spray 330 and the lengthwise high pressure spray 340 are positioned perpendicular to each other.

The widthwise high pressure spray 330 comprises a widthwise nozzle portion 331 disposed along the direction of movement of the substrate 100. The widthwise high pressure spray 330 supplies a washing fluid 332 as a treating fluid to the substrate 100. The widthwise high pressure spray 330 is disposed near an edge of the substrate 100. The moving mechanism 500 supports the substrate 100 at an inclined angle with the edge of the substrate 100 adjacent to the widthwise high pressure spray 330 being positioned at a higher elevation than the opposite edge of the substrate 100, as shown in FIG. 4. The length L1 of the widthwise nozzle portion 331 may be about 50% of the length L2 of the long side of the substrate 100.

The lengthwise high pressure spray 340 comprises a lengthwise nozzle portion 341 extending laterally across the substrate 100 in a direction substantially perpendicular to the direction of travel of the substrate 100. The lengthwise high pressure spray 340 supplies a washing fluid 342 as the treating fluid to the substrate 100. The length L3 of the lengthwise nozzle portion 341 may be a little longer than the length L4 of the short side of the substrate 100.

The widthwise high pressure spray 330 and the lengthwise high pressure spray 340 may be modified in various ways. For example, the widthwise nozzle portion 331 may be formed by a plurality of injecting holes arranged in a row. A plurality of the widthwise high pressure sprays 330 and the lengthwise high pressure sprays 340 may be provided. The widthwise high pressure spray 330 and the lengthwise high pressure spray 340 may be formed as a single body.

A method of treating the substrate 100 using the apparatus for treating a substrate according to a second embodiment of the present invention will be described, with particular focus on the washing module 300.

In the washing module 300, the washing fluid 332 and washing fluid 342 are applied to the substrate 100 from the widthwise nozzle portion 331 of the widthwise high pressure spray 300 and the lengthwise nozzle portion 341 of the lengthwise high pressure spray 340, respectively. The washing fluid 332 and washing fluid 342 remove the etching solution 211 and the portions of the gate metal layer etched by the etching solution 211 from the substrate 100.

The moving mechanism 500 supports the substrate 100 at a predetermined inclined angle Θ. The widthwise high pressure spray 330 is positioned along the elevated edge of the substrate 100. Due to the incline of the substrate 100, the washing fluid 331 applied from the widthwise nozzle portion 331 flows downwards across the upper face of the inclined substrate 100 towards the lowered edge of the substrate 100.

As the washing fluid 332 and washing fluid 342 is applied by the lengthwise high pressure spray 340 together with the widthwise high pressure spray 330, the etching solution 211 and the portions of the gate metal layer etched by the etching solution 211 are quickly removed from the substrate 100. In addition, the residual time of that the etching solution 211 remains on the surface of the substrate remains substantially uniform at all positions across the face of the substrate 100.

The widthwise high pressure spray 330 and the lengthwise high pressure spray 340 quickly remove the etching solution 211 and the etched gate metal layer from the substrate 100, and then the spray module 320 further applies additional washing fluid 321 to wash the substrate 100.

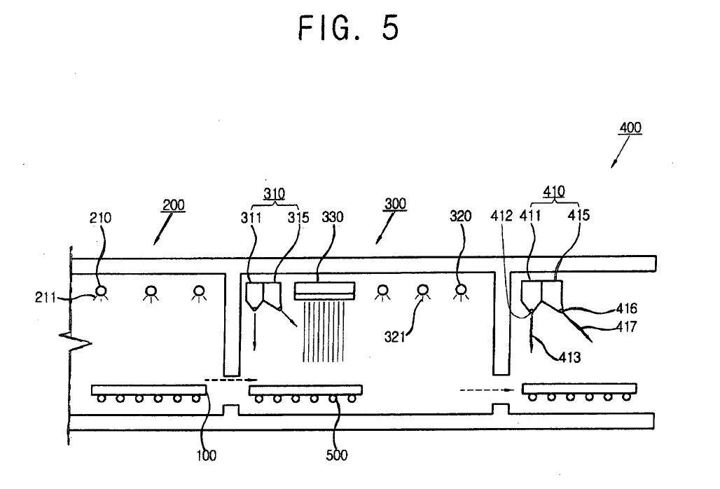

FIG. 5 is a cross-sectional view of an apparatus for treating a substrate according to a third embodiment of the present invention.

A high pressure spray unit 310, a widthwise knife unit 330, and a spray module 320 are disposed sequentially along the direction of movement of a substrate 100. The high pressure spray unit 310 prevents washing fluid from the washing module 300 from flowing backward into the etching module 200. In addition, the widthwise high pressure spray unit 330 sprays washing fluid 332 to quickly remove the etching solution 211 from the substrate 100.

The present invention is not limited to treating etched substrates, and may also be applied in other embodiments to treating developed substrates.

The present invention is not limited to manufacturing substrates for liquid crystal displays, and may also be applied to semiconductor manufacturing processes, such as the manufacturing of semiconductor wafers and substrates for flat panel displays, such as organic light emitting diodes.

Although various embodiments of the present invention have been shown and described, it will be appreciated by those of ordinary skill in the art that changes may be made in these embodiments without departing from the principles and spirit of the invention, the scope of which is defined in the appended claims and their equivalents.

What is claimed is:

1. An apparatus for treating substrates, comprising:
a moving mechanism for moving a substrate; and
a high pressure spray unit comprising a first high pressure spray having a first nozzle portion disposed transverse to a direction of movement of the substrate and a second high pressure spray having a second nozzle portion parallel to the first nozzle portion.

2. The apparatus for treating substrates according to claim 1, wherein at least one of the first nozzle portion and the second nozzle portion directs fluid at an oblique angle to the surface of the substrate.

3. The apparatus for treating substrates according to claim 1, wherein a treating fluid from the first high pressure spray is applied to the substrate prior to supply of a treating fluid from the second high pressure spray, and the treating fluid from the first high pressure spray comprises air and the treating fluid from the second high pressure spray comprises water.

4. The apparatus for treating substrates according to claim 1, wherein a treating fluid from the first high pressure spray is applied to the substrate prior to application of a treating fluid from the second high pressure spray, and the treating fluid from the first high pressure spray comprises room-temperature air and the treating fluid from the second high pressure spray comprises heated air.

5. The apparatus for treating substrates according to claim 1, further comprising a widthwise high pressure spray having a widthwise nozzle portion disposed along the direction of movement of the substrate.

6. An apparatus for treating substrates comprising:
a moving mechanism for moving a substrate; and
a widthwise high pressure spray having a widthwise nozzle portion disposed along a direction of movement of the substrate.

7. The apparatus for treating substrates according to claim 6, further comprising a lengthwise high pressure spray having a lengthwise nozzle portion disposed transverse to the direction of movement of the substrate.

8. The apparatus for treating substrates according to claim 7, wherein a treating fluid from the widthwise high pressure spray and the lengthwise high pressure spray comprises water.

9. The apparatus for treating substrates according to claim 6, wherein:
the moving mechanism supports the substrate at an inclined angle; and
the widthwise high pressure spray is disposed along an elevated edge of the substrate.

10. An apparatus for treating substrates, comprising:
a moving mechanism for moving a substrate in a first direction; and
a washing module, comprising a first high pressure spray unit, said first high pressure spray unit comprising:
a first elongate spray nozzle extending across a length of the substrate transverse to the first direction; and
a second elongate spray nozzle extending across a width of the substrate parallel to the first direction.

11. The apparatus of claim 10, wherein the second elongate spray nozzle directs fluid at an oblique angle to the surface of the substrate.

12. The apparatus of claim 10, wherein:
the first elongate spray nozzle applies a compressed gas to an upper surface of the substrate; and
the second elongate spray nozzle applies water to the upper surface of the substrate.

13. The apparatus of claim 10, wherein:
the first elongate spray nozzle applies compressed room-temperature air to an upper surface of the substrate; and
the second elongate spray nozzle applies compressed heated air to the upper surface of the substrate.

14. The apparatus of claim 10, further comprising:
a widthwise high pressure spray comprising an elongate nozzle portion extending along the first direction.

15. The apparatus of claim 14, further comprising:
a lengthwise high pressure spray comprising an elongate nozzle portion disposed transverse to the first direction.

16. The apparatus of claim 15, wherein:
the widthwise high pressure spray and the lengthwise high pressure spray apply water to the substrate.

17. The apparatus of claim 15, wherein:
the moving mechanism supports the substrate at an inclined angle; and
the widthwise high pressure spray is disposed along an elevated edge of the substrate.
